(19) United States
(12) Patent Application Publication
(10) Pub. No.: US 2009/0188335 A1
(43) Pub. Date: Jul. 30, 2009

(54) Mechanical gripper

(75) Inventors: Larry A. Brow, Livonia, MI (US); Kevin Nedziek, Howell, MI (US)

Correspondence Address: DRINKER BIDDLE & REATH (DC), 1500 K STREET, N.W., SUITE 1100, WASHINGTON, DC, 20005-1209, US

(73) Assignee: VALENITE LLC

(21) Appl. No.: 12/010,609

(22) Filed: Jan. 28, 2008

(51) Int. Cl. F16H 31/00

(52) U.S. Cl. 74/63

(57) ABSTRACT

A device is disclosed for manipulating a rotatable adjusting mechanism including a base and a plurality of protrusions extending axially from a first end of the base, wherein the protrusions radially flex at least outwardly relative to each other. The plurality of protrusions extend axially from a radial edge of the first end of the base and include a thinned portion at a basal section and a rotatable contacting surface at a distal section. A method of manipulating a rotatable adjusting mechanism mounted on a material removal tool by positioning the rotatable adjusting mechanism within the plurality of protrusions, wherein the protrusions radially flex at least outwardly relative to each other, and rotating the material removal tool about its axis is also disclosed.

### FIELD

The present disclosure relates to a device to manipulate an adjusting mechanism. More particularly, the present disclosure relates to a device with axial extending protrusions that receive an adjustment mechanism, which can then be adjusted, and also relates to a method to manipulate an adjusting mechanism on a material removal tool, such as an adjusting mechanism that delimits axial travel of a translating bar that is actuated to change the position of at least one cutting element relative to the material removal tool.

### BACKGROUND

In the discussion of the background that follows, reference is made to certain structures and/or methods. However, the following references should not be construed as an admission that these structures and/or methods constitute prior art. Applicant expressly reserves the right to demonstrate that such structures and/or methods do not qualify as prior art.

Automated machining ideally provides the ability to calibrate and adjust cutting positions on machine tools. Such calibrations and adjustment can be performed manually, but such manual operation disrupts the automated features of the machine. Alternatively, such calibrations and adjustment can be performed automatically by use of a gripping device to allow manipulation of an adjustment mechanism. However, such grippers have been previously manipulated by a pressurized fluid, such as air, or by mechanical manipulation, such as by a power actuator or a motor, either method using a supply line and a controller, which add complexity and cost to the system.

### SUMMARY

An exemplary embodiment of a device for manipulating a rotatable adjusting mechanism comprises a base and a plurality of protrusions extending axially from a first end of the base, wherein the protrusions radially flex at least outwardly relative to each other.

An exemplary method of manipulating a rotatable adjusting mechanism mounted on a material removal tool comprises positioning the rotatable adjusting mechanism within a plurality of protrusions extending axially from a first end of a base, wherein the protrusions radially flex at least outwardly relative to each other, and rotating the material removal tool about its axis.

It is to be understood that both the foregoing general description and the following detailed description are exemplary and explanatory and are intended to provide further explanation of the invention as claimed.

### BRIEF DESCRIPTION OF THE DRAWING

The following detailed description can be read in connection with the accompanying drawings in which like numerals designate like elements and in which:

FIG. 1 schematically illustrates an exemplary embodiment of a device for manipulating a rotatable adjusting mechanism.

FIG. 2 is an axial view of the device for manipulating a rotatable adjusting mechanism shown in FIG. 1.

FIG. 3 is a schematic view of the device for manipulating a rotatable adjusting mechanism shown in FIG. 1 illustrating the position of a rotatable adjusting mechanism relative to the device.

FIG. 4 shows an alternative exemplary embodiment of a device for manipulating a rotatable adjusting mechanism.

### DETAILED DESCRIPTION

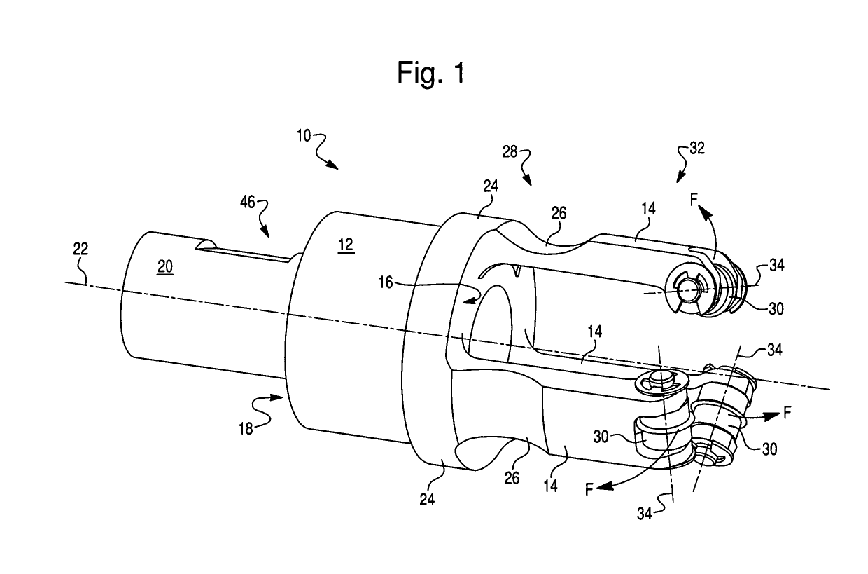

FIG. 1 schematically illustrates an exemplary embodiment of a device for manipulating a rotatable adjusting mechanism. In the FIG. 1 exemplary embodiment, the device for manipulating a rotatable adjusting mechanism 10 comprises a base 12 and a plurality of protrusions 14 extending axially from a first end 16 of the base 12. At a second end 18 of the base 12, the device 10 includes a mounting shaft 20. The base 12 and the plurality of protrusions 14 are arranged in axial relation along an axis 22 of the device 10. Alternatively, the mounting shaft 20, the base 12 and the plurality of protrusions 14 are arranged in axial relation along the axis 22 of the device 10. In an exemplary embodiment, the plurality of protrusions 14 extend axially from a radial edge 24 of the first end 16 of the base 12.

In general, the plurality of protrusions 14 are radially flexible and torsionally stiff. In exemplary embodiments, the plurality of protrusions 14 radially flex F at least outwardly relative to each other. For example, the plurality of protrusions 14 can include a thinned portion 26, wherein the thinned portion 26 facilitates the radial flexing of the protrusion 14. Such a thinned portion 26, or other feature promoting outward flexing of the protrusion 14, can be on at least one of the plurality of protrusions 14, alternatively can be on each of the plurality of protrusions 14. In an exemplary embodiment, the thinned portion 26 is at a basal section 28 of the protrusion 14.

Although the thinned portion 26 allows for radial flexing of the protrusion, the thinned portion and other dimensions of the protrusion limit or reduce torsional deflection of the protrusion. In exemplary embodiments, the width W or diameter of the protrusion reduces the torsional deflection, e.g., but increasing the aspect ratio in opposition to the torsional deflection. In one example, radial flexing is orders of magnitude greater than torsional deflection. In additional examples, because the rotatable adjusting mechanism can rotate under a low torque, less torsional force is generated.

In exemplary embodiments, at least one of the plurality of protrusions 14, alternatively each of the plurality of protrusions 14, includes a rotatable contacting surface 30 at a distal section 32 thereof. As shown in FIG. 1, the basal section 28 is closer to the base 12 than is the distal section 32.

The rotatable contacting surface 30 is spaced apart from the axis 22 of the device 10. In one example, the rotatable contacting surface 30 can rotate about an axis 34 that is non-parallel to the axis 22 of the device 10. In another example, the axis 34 about which the rotatable contacting surface 30 rotates is non-intersecting with the axis 22 of the device 10.

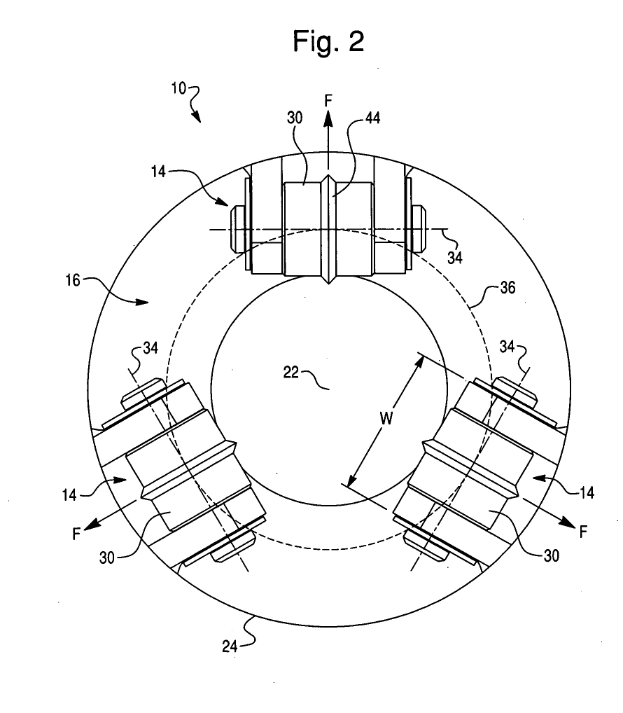

In exemplary embodiments, the plurality of protrusions 14 bound a space into which a rotatable adjusting mechanism can be positioned. FIG. 2 is an axial view of the device for manipulating a rotatable adjusting mechanism 10 shown in FIG. 1. In FIG. 2, the space 36 is shown.

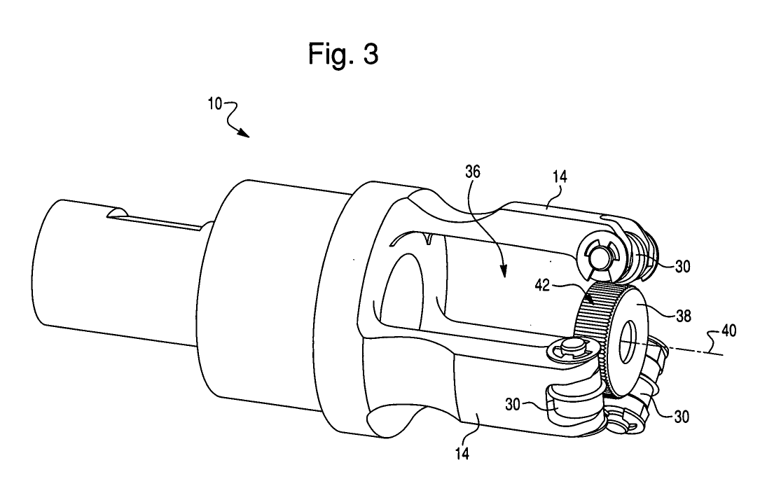

FIG. 3 is a schematic view of the device for manipulating a rotatable adjusting mechanism 10 illustrating the position of a rotatable adjusting mechanism relative to the device 10. In the FIG. 3 view, a contacting feature 38 of a rotatable adjusting mechanism is shown and the remaining features of the material removal tool on which the contacting feature is mounted are not shown for clarity. However, an example of a suitable material removal tool is an actuated material removal tool in which an axial position of a translating bar is translated to change a radial movement of one or more cutting inserts. The axial translation of the translating bar is limited by a delimiting structure at a first end of the material removal tool. An example of a delimiting structure is an adjustment assembly including a contact surface that limits axial movement of the translating bar in at least one axial direction, which thereby limits the amount of radial movement of the one or more cutting inserts. In one example, an axial position of the contact surface can be adjusted by rotation of a knob or dial of the adjustment assembly. An example of a suitable material removal tool with such a delimiting structure is disclosed in copending application Ser. No. 60/924,785 entitled ACTUATED MATERIAL REMOVAL TOOL and filed provisionally on May 31, 2007, the entire contents of which are incorporated herein by reference.

In an exemplary method of manipulating a rotatable adjusting mechanism 10, such as when a rotatable adjusting mechanism is mounted on a material removal tool, the rotatable adjusting mechanism is positioned within a plurality of protrusions 14 extending axially from a first end 16 of a base 12, wherein the protrusions 14 radially flex at least outwardly relative to each other. The material removal tool is then rotated about its axis 40 while the contacting feature 38 is held stationary.

When the material removal tool is rotated about its longitudinal axis 40, the surface 42 of the rotatable adjusting mechanism is held stationary resulting in an axial movement of a portion of the adjusting mechanism. The axial movement of the portion of the adjusting mechanism is relative to a portion of the material removal tool, for example, a translating bar of a boring tool.

In one aspect, the surface 42 of the rotatable adjusting mechanism is held stationary by the rotatable contacting surface 30 at the distal section 32 of the protrusions 14 in contact with the surface 42 of the rotatable adjusting mechanism or by another locking mechanism. In exemplary embodiments, the rotatable contacting surface 30 is textured to complement at least a portion of a surface 42 of the rotatable adjusting mechanism on the portion of the rotatable adjusting mechanism, e.g., the rotatable contacting surface and a knurled knob of the rotatable adjusting mechanism are correspondingly textured. In another aspect, the surface 42 of the rotatable adjusting mechanism is held stationary by the opposing orientation of the axis 34 of rotation of the rotatable contacting surfaces 30 and the axis 40 of the material removal tool. An example of a textured surface is a ridge 44 shown in FIG. 2. In another aspect, the surface 42 of the rotatable adjusting mechanism is held stationary by the biasing force established by the outwardly flexed protrusions. For example, the biasing force can be one or more of radially inward or substantially perpendicular to the axis 40 of the material removal tool. In a further aspect, one of more of the above means to hold stationary the surface 42 of the rotatable adjusting mechanism can be used, alone or in combinations. However, such means to hold stationary the surface 42 of the rotatable adjusting mechanism is without assistance of a pressurized fluid, such as air, or without assistance of mechanical manipulation, such as a power actuator or a motor.

Rotating the material removal tool about its axis includes rotation by a predetermined amount. For example, the predetermined amount can be a multiple of a whole number of degrees or radians or a multiple of a fractional number of degrees or radians that correlates to a given axial movement of the portion of the adjusting mechanism. In addition, examples of the predetermined amount can be less than or greater than 360 degrees or 2π radians. Rotating the material removal tool about its axis provides precision adjustment. For example, the amount of rotation, e.g., the predetermined amount, are calibrated to a known axial movement of the portion of the adjusting mechanism.

In an exemplary embodiment of the method, positioning the rotatable adjusting mechanism within a plurality of protrusions 14 includes moving at least a surface 42 of the rotatable adjusting mechanism into a space 36 bounded by the plurality of protrusions 14, outwardly flexing F at least one of the plurality of protrusions 14, and contacting the surface 42 of the rotatable adjusting mechanism with one or more of the rotatable contacting surfaces 30. The outwardly flexed protrusion establishes a biasing force to contact the surface 42 of the rotatable adjusting mechanism with one or more of the rotatable contacting surfaces 30. Generally, the axis of the material removal tool is parallel or substantially parallel, e.g., within a range of 0 to ±60°, within a range of 0 to ±45°, within a range of 0 to ±30°, within a range of 0 to ±15°, within a range of 0 to ±10°, alternatively within a range of 0 to ±5° of parallel, with the axis 22 of the device for manipulating a rotatable adjusting mechanism 10.

During the exemplary method, the one or more rotatable contacting surfaces can optionally rotate during the positioning of the rotatable adjusting mechanism, e.g., as the surface 42 of the rotatable adjusting mechanism axially (in relation to axis 22) passes past the rotatable contacting surfaces 30, the rotatable contacting surfaces 30 rotate about their axis 34. This rotating motion reduces interference friction between the surface 42 of the rotatable adjusting mechanism and the rotatable contacting surfaces 30.

In an exemplary embodiment, the method adjusts a position of at least one cutting insert cartridge on a material removal tool, alternatively adjusts a position of a plurality of cutting insert cartridges. For example, the plurality of cutting insert cartridges can be three or more cutting insert cartridges arranged symmetrically about an outer surface of the material removal tool. Such a material removal tool can be, for example, a boring tool.

In exemplary embodiments, the device for manipulating a rotatable adjusting mechanism 10 can be mounted on an outer surface of a machine tool, or, for another example, can be mounted on a surface of a machine tool accessible by a computer controlled manipulating device to position a rotatable adjusting mechanism of a material removal tool within the space bound by the plurality of protrusions 14. To assist in mounting or locating the device 10, the device 10 can optionally include a keyway 46. The keyway 46 can radially orient the device 10 when mounted. In one exemplary embodiment, the keyway 36 is located on the mounting shaft 20.

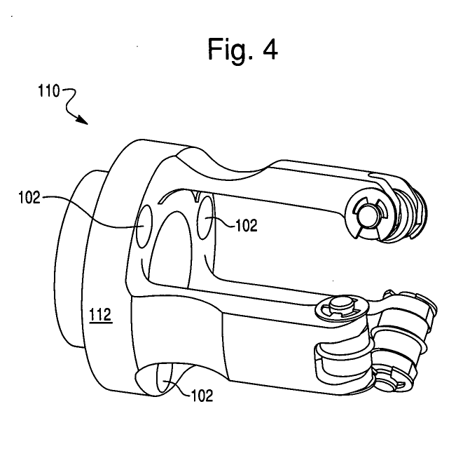

FIG. 4 shows an alternative embodiment of a device for manipulating a rotatable adjusting mechanism 110. FIG. 4 has similar features to those shown in FIGS. 1-3, but without a shaft portion. Rather, the base 112 is directly mountable, for example by connectors in pilot holes 102. All other features and operations of the rotatable adjusting mechanism 110 are substantially the same as those disclosed herein in regard to the rotatable adjusting mechanism 10 shown and described in regard to FIGS. 1-3.

Although described in connection with preferred embodiments thereof, it will be appreciated by those skilled in the art that additions, deletions, modifications, and substitutions not specifically described may be made without department from the spirit and scope of the invention as defined in the appended claims.

What is claimed is:

1. A device for manipulating a rotatable adjusting mechanism, the device comprising:
a base; and
a plurality of protrusions extending axially from a first end of the base, wherein the protrusions radially flex at least outwardly relative to each other.

2. The device according to claim 1, wherein the plurality of protrusions extend axially from a radial edge of the first end of the base.

3. The device according to claim 1, wherein the base and the plurality of protrusions are arranged in axial relation along an axis of the device.

4. The device according to claim 1, including a mounting shaft at a second end of the base.

5. The device according to claim 4, wherein the mounting shaft, the base and the plurality of protrusions are arranged in axial relation along the axis of the device.

6. The device according to claim 1, wherein the plurality of protrusions include a thinned portion at a basal section and a rotatable contacting surface at a distal section, and wherein the basal section is closer to the base than is the distal section.

7. The device according to claim 1, wherein at least one of the plurality of protrusions include a thinned portion at a basal section.

8. The device of claim 1, including a rotatable contacting surface at a distal section of at least one of the plurality of protrusions.

9. The device of claim 8, wherein the rotatable contacting surface rotates about an axis that is non-parallel to an axis of the device.

10. The device of claim 9, wherein the base and the plurality of protrusions are arranged in axial relation along the axis of the device

11. The device of claim 8, wherein the axis about which the rotatable contacting surface rotates is non-intersecting with an axis of the device.

12. The device of claim 1, including a rotatable contacting surface at a distal section of at least one of the plurality of protrusions, wherein the rotatable contacting surface is textured to complement at least a portion of a surface of the rotatable adjusting mechanism.

13. A method of manipulating a rotatable adjusting mechanism, the rotatable adjusting mechanism mounted on a material removal tool, the method comprising:
positioning the rotatable adjusting mechanism within a plurality of protrusions extending axially from a first end of a base, wherein the protrusions radially flex at least outwardly relative to each other; and
rotating the material removal tool about its axis.

14. The method of claim 13, wherein at least one of the plurality of protrusions includes a rotatable contacting surface at a distal section thereof.

15. The method of claim 14, wherein the rotatable contacting surface is textured to complement at least a portion of a surface of the rotatable adjusting mechanism on the portion of the rotatable adjusting mechanism.

16. The method of claim 14, wherein, when the material removal tool is rotated about a longitudinal axis, the portion of the surface of the rotatable adjusting mechanism is held stationary resulting in an axial movement of a portion of the adjusting mechanism.

17. The method of claim 13, wherein positioning the rotatable adjusting mechanism within a plurality of protrusions includes:
moving at least a surface of the rotatable adjusting mechanism into a space bounded by the plurality of protrusions;
outwardly flexing at least one of the plurality of protrusions; and
contacting the surface of the rotatable adjusting mechanism with one or more of the rotatable contacting surfaces.

18. The method of claim 17, wherein the outwardly flexed protrusion establishes a biasing force to contact the surface of the rotatable adjusting mechanism with one or more of the rotatable contacting surfaces.

19. The method of claim 18, wherein the biasing force is radially inward

20. The method of claim 18, wherein the biasing force is substantially perpendicular to an axis of the material removal tool.

21. The method of claim 17, including rotating the one or more rotatable contacting surfaces during the positioning of the rotatable adjusting mechanism.

22. The method of claim 21, wherein the axis about which the one or more rotatable contacting surfaces rotates is non-parallel to an axis of the device, wherein the base and the plurality of protrusions are arranged in axial relation along the axis of the device.

23. The method of claim 21, wherein the axis about which the one or more rotatable contacting surfaces rotates is non-intersecting with an axis of the device, wherein the base and the plurality of protrusions are arranged in axial relation along the axis of the device.

24. The method of claim 16, wherein the axial movement of the portion of the adjusting mechanism is relative to a portion of the material removal tool.

25. The method of claim 24, wherein the portion of the material removal tool is a translating bar of a boring tool.

26. The method of claim 13, wherein a mounting shaft is included at a second end of the base, wherein the mounting shaft, the base and the plurality of protrusions are arranged in axial relation along the axis of the device

27. The method of claim 13, wherein the plurality of protrusions extend axially from a radial edge of the first end of the base.

28. The method of claim 13, wherein the rotatable adjusting mechanism is located on a material removal tool.

29. The method of claim 28, wherein the method adjusts a position of at least one cutting insert cartridge on the material removal tool.

30. The method of claim 28, wherein the material removal tool is a boring tool.
